(19) United States
(12) Patent Application Publication
(10) Pub. No.: US 2021/0253261 A1
(43) Pub. Date: Aug. 19, 2021

(54) AIRCRAFT AND CONTROL METHOD FOR SAME

(71) Applicant: HONDA MOTOR CO., LTD., Minato-ku, Tokyo (JP)

(72) Inventors: Jun Furukawa, Wako-shi, Saitama-ken (JP); Masashi Kato, Wako-shi, Saitama-ken (JP)

(21) Appl. No.: 17/251,830

(22) PCT Filed: Jun. 18, 2019
(86) PCT No.: PCT/JP2019/024116

§ 371 Date: Dec. 14, 2020

(30) Foreign Application Priority Data
Jun. 19, 2018 (JP) 2018-115884

(51) Int. Cl. B64D 31/04; B64C 27/20

(52) U.S. Cl. CPC B64D 31/04; B64C 27/10; B64C 27/20

(57) ABSTRACT

An aircraft and a control method therefor, wherein a prescribed range in a P1 direction and a P2 direction that are centered on a neutral position is set as a neutral area for a grip handle. In accordance with the position or amount of operation of the grip handle, a flight controller makes the aircraft advance or reverse. When the grip handle as operated in the P1 direction or the P2 direction has moved into the neutral area, the flight controller makes the aircraft decelerate.

### TECHNICAL FIELD

The present invention relates to an aircraft capable of flying through the air based on manipulation of a manipulating section by a rider, and to a control method for the aircraft.

### BACKGROUND ART

Japanese Laid-Open Patent Publication No. 2011-131861 discloses causing a vertical takeoff and landing machine to fly in a desired direction, by relatively moving weight while the rider manipulates a handlebar to the front, rear, left, and right. For example, the machine can be made to advance by drawing the handlebar toward the rider, and can be made to turn left by pressing the handlebar forward and to the right.

Furthermore, the Internet site of Hoversurf, Hoverbike HOVER ONE, [Searched May 17, 2018], <URL: https://www.hoversurf.com/scorpion-3> discloses adjusting the roll angle, pitch angle, yaw rate, altitude, and the like of an aircraft by having a rider manipulate joysticks provided to the left and right of the position of the rider.

### SUMMARY OF INVENTION

During an emergency, such as when the rider removes their hands from the handlebar during flight, it is preferable for the velocity to quickly become 0, that is, for the aircraft to enter a hovering state. However, with the aircraft of the documents mentioned above, even when the rider removes their hands from the handlebar during flight at a certain velocity, only the decelerating force of air resistance acts on the machine. Therefore, the velocity cannot quickly reach 0.

The present invention has been devised in order to solve this type of problem, and has the object of providing an aircraft that can decelerate quickly with a simple configuration, and a control method for this aircraft.

An aspect of the present invention concerns an aircraft including a manipulating section that is manipulated by a rider and a control section that controls flight in air based on manipulation of the manipulating section by the rider, and a control method of this aircraft.

The manipulating section is manipulated by the rider in a first manipulation direction relative to a neutral position or in a second manipulation direction, which is different than the first manipulation direction, relative to the neutral position, a prescribed range in the first manipulation direction and the second manipulation direction, centered on the neutral position, is set as a neutral region for the manipulating section.

The control section moves the aircraft in a first movement direction according to a manipulation amount of the manipulating section in the first manipulation direction from the neutral position, or moves the aircraft in a second movement direction, which is different than the first movement direction, according to a manipulation amount of the manipulating section in the second manipulation direction from the neutral position. Furthermore, the control section decelerates the aircraft if a position of the manipulating section that has been manipulated in the first manipulation direction or the second manipulation direction has moved into the neutral region.

According to the present embodiment, if the position of the manipulating section is moved into the neutral region while in flight, the aircraft decelerates, and therefore it is possible for the velocity of the aircraft to quickly become 0, i.e., for the aircraft to enter the hovering state. Therefore, it is possible to realize a fail-safe during an emergency, with a simple configuration.

### BRIEF DESCRIPTION OF DRAWINGS

FIG. 1 is a perspective view of an aircraft according to the present embodiment;

FIGS. 2A and 2B are schematic diagrams of the handlebar grip (manipulating section) of FIG. 1;

FIG. 3 is a descriptive diagram of a neutral position and a neutral region;

FIGS. 4A and 4B are schematic configurational diagrams showing modifications of FIGS. 2A and 2B;

FIG. 5 is a block diagram of the aircraft of FIG. 1;

FIG. 6 is a state transition diagram of an operation of the aircraft of FIG. 1;

FIG. 7 is a flow chart showing the transition between the advancing acceleration state and the advancing deceleration state in FIG. 6;

FIG. 8 is a flow chart showing the transition from the advancing acceleration state to the emergency stopping state in FIG. 6;

FIG. 9 is a flow chart showing the transition between the advancing deceleration state and the emergency stopping state in FIG. 6;

FIG. 10 is a flow chart showing the transition from the advancing deceleration state to the hovering state in FIG. 6; and

FIG. 11 is a state transition diagram of a modification of FIG. 6.

### DESCRIPTION OF EMBODIMENTS

The following describes preferred embodiments of an aircraft and a control method thereof according to the present invention, while referencing the accompanying drawings.

### [1. Configuration of the Present Embodiment]

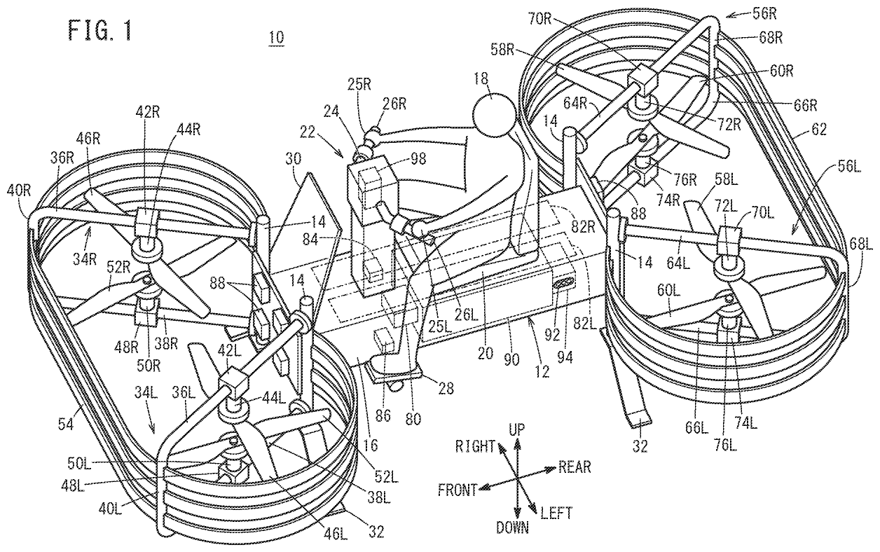

As shown in FIG. 1, an aircraft 10 according to the present embodiment is a multicopter including a body frame 12 with a rectangular shape that is long in the front-rear direction. The body frame 12 is formed to include a skeletal body 14, which is a plurality of rod-shaped members such as pipe members combined into a parallelepiped, and eight exterior panels 16 attached to the skeletal body 14 in a manner to close each plane of the skeletal body 14. A portion of the skeletal body 14 is exposed to the outside from the external panels 16.

A rider seat 20 in which a rider 18 sits is provided on a top portion of the body frame 12. The following description is provided using the front, rear, left, right, up, and down directions as seen from the rider 18 sitting in the seat 20. Furthermore, in the following description, for configurational elements that are arranged in left-right sets, there are cases where the letters “L” and “R” are appended to the reference numerals to indicate left and right configurational elements.

A steering apparatus 22 is provided in front of the seat 20. The steering apparatus 22 includes a steering handlebar 24 that can be steered by the rider 18, and handlebar grips (manipulating sections) 26L and 26R, which are gripped by left and right hands 25L and 25R of the rider 18, are provided at the left and right end portions of the steering handlebar 24.

Steps 28, where the feet of the rider 18 seated on the seat 20 are placed, are provided on the left and right sides of the body frame 12. A windshield hood 30, made of a transparent acrylic board or the like, is mounted in front of the steering apparatus 22 of the body frame 12. Leg-shaped landing gears 32 are attached at four locations at the front, rear, left, and right of the body frame 12.

A left-right pair of front support arms 34L and 34R are attached to the front portion of the skeletal body 14, by rod-shaped members such as pipe members. The left-side front support arm 34L is an arm member extending forward and to the left from the skeletal body 14, and includes an upper arm 36L that extends forward and to the left from the top left corner of the skeletal body 14, a lower arm 38L that extends forward and to the left, parallel to the upper arm 36L, from the bottom left corner of the skeletal body 14, and a connection rod 40L that connects a tip portion of the upper arm 36L and a tip portion of the lower arm 38L.

The right-side front support arm 34R is an arm member extending forward to the right from the skeletal body 14, and includes an upper arm 36R that extends forward and to the right from the top right corner of the skeletal body 14, a lower arm 38R that extends forward and to the right, parallel to the upper arm 36R, from the bottom right corner of the skeletal body 14, and a connection rod 40R that connects a tip portion of the upper arm 36R and a tip portion of the lower arm 38R.

Electric motors 44L and 44R are attached facing downward to an intermediate portion between the left and right upper arms 36L and 36R, via mounting members 42L and 42R. Double-bladed rotor wings 46L and 46R, which rotate centered on output shafts of respective electric motors 44L and 44R that extend downward, are attached horizontally to these output shafts.

On the other hand, electric motors 50L and 50R are attached facing upward to an intermediate portion between the left and right lower arms 38L and 38R, via mounting members 48L and 48R. In this case, double-bladed rotor wings 52L and 52R, which rotate centered on output shafts of the respective electric motors 50L and 50R that extend upward, are attached horizontally to these output shafts.

A guard member 54 is attached to the front portion of the body frame 12. Both ends of the guard member 54 are fixed to the body frame 12, and the guard member 54 is a board-shaped member with an oval shape extending in the left-right direction in a manner to surround the four rotor wings 46L, 46R, 52L, and 52R. In this case, the connection rods 40L and 40R are connected to the left and right sides of the front portion of the guard member 54.

A left-right pair of rear support arms 56L and 56R, four rotor wings 58L, 58R, 60L, and 60R, and a rear guard member 62 are provided at a rear portion of the skeletal body 14. The left-right pair of rear support arms 56L and 56R, the four rotor wings 58L, 58R, 60L, and 60R, and the rear guard member 62 respectively have the same configurations as the left-right pair of front support arms 34L and 34R, the four forward rotor wings 46L, 46R, 52L, and 52R, and the guard member 54.

In other words, the left-side rear support arm 56L is an arm member realized by a rod-shaped member such as a pipe member extending backward and to the left from the skeletal body 14, and includes an upper arm 64L that extends backward and to the left from the top left corner of the skeletal body 14, a lower arm 66L that extends backward and to the left, parallel to the upper arm 64L, from the bottom left corner of the skeletal body 14, and a connection rod 68L that connects a tip portion of the upper arm 64L and a tip portion of the lower arm 66L.

The right-side rear support arm 56R is an arm member realized by a rod-shaped member such as a pipe member extending backward and to the right from the skeletal body 14, and includes an upper arm 64R that extends backward and to the right from the top right corner of the skeletal body 14, a lower arm 66R that extends backward and to the right, parallel to the upper arm 64R, from the bottom right corner of the skeletal body 14, and a connection rod 68R that connects a tip portion of the upper arm 64R and a tip portion of the lower arm 66R.

Electric motors 72L and 72R are attached facing downward to an intermediate portion between the left and right upper arms 64L and 64R, via mounting members 70L and 70R. Double-bladed rotor wings 58L and 58R, which rotate centered on output shafts of the respective electric motors 72L and 72R that extend downward, are attached horizontally to these output shafts. Electric motors 76L and 76R are attached facing upward to an intermediate portion between the left and right lower arms 66L and 66R, via mounting members 74L and 74R. Double-bladed rotor wings 60L and 60R, which rotate centered on output shafts of the respective electric motors 76L and 76R that extend upward, are attached horizontally to these output shafts.

The rear guard member 62 is attached to the rear portion of the body frame 12. Both ends of the rear guard member 62 are fixed to the body frame 12, and the rear guard member 62 is a board-shaped member with an oval shape extending in the left-right direction in a manner to surround the four rotor wings 58L, 58R, 60L, and 60R. In this case, the connection rods 68L and 68R are connected to the left and right sides of the rear portion of the rear guard member 62.

The front and rear electric motors 44L, 44R, 50L, 50R, 72L, 72R, 76L, and 76R each independently rotationally drive a corresponding one of the rotor wings 46L, 46R, 52L, 52R, 58L, 58R, 60L, and 60R connected to the output shaft thereof. Specifically, in each set of two rotor wings 46L, 46R, 52L, 52R, 58L, 58R, 60L, and 60R arranged facing each other in the up-down direction, the rotor wings are rotationally driven in opposite directions from each other. The left-side rotor wings 46L, 52L, 58L, and 60L and the right-side rotor wings 46R, 52R, 58R, and 60R are arranged with left-right symmetry relative to a centerline extending in the front-rear direction of the body frame 12. In other words, the aircraft 10 includes pairs of left-right and counter-rotating rotor wings 46L, 46R, 52L, 52R, 58L, 58R, 60L, and 60R arranged with left-right symmetry.

A flight controller (control section) 80, load cells 82L and 82R, an inertial navigation apparatus (IMU) 84, a downward distance sensor 86, a plurality of ESCs (Electronic Speed Controllers) 88 that individually control each of the electric motors 44L, 44R, 50L, 50R, 72L, 72R, 76L, and 76R, a battery 90, and a battery charger 94 with a connection plug 92 are attached to the body frame 12. The flight controller 80 controls each section of the aircraft 10 described below, by reading and executing a program stored in a memory (not shown in the drawings).

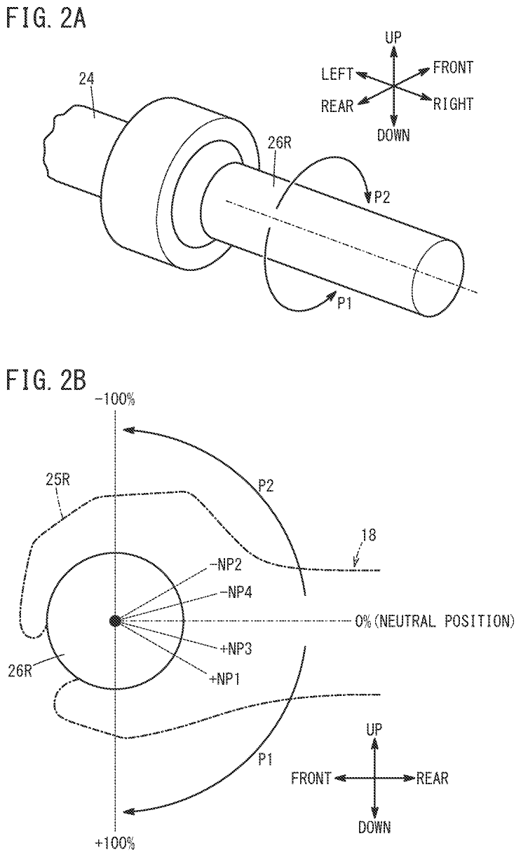

FIGS. 2A and 2B are descriptive diagrams showing manipulations of the handlebar grip 26R by the rider 18. In the present embodiment, when the rider 18 manipulates the steering handlebar 24 or the handlebar grip 26R, the flight controller 80 (see FIG. 1) controls the flight of the aircraft 10 by controlling each of the electric motors 44L, 44R, 50L, 50R, 72L, 72R, 76L, and 76R according to the manipulation amount of the steering handlebar 24 or the handlebar grip 26R.

Specifically, in a state where the rider 18 is gripping the handlebar grips 26L and 26R with their left and right hands 25L and 25R, when the steering handlebar 24 (see FIG. 1) is steered around an axis in the up-down direction (yaw direction), it is possible to turn the aircraft 10. Furthermore, as an example, when the right-side handlebar grip 26R is rotated forward, i.e., in a P1 direction (first manipulation direction), from a neutral position (neutral point) by the hand 25R (also referred to below as the right hand 25R) of the rider 18, the aircraft 10 can be made to fly forward (advancement direction, first movement direction). Furthermore, when the handlebar grip 26R is rotated by the rider 18 in a P2 direction (second manipulation direction), the aircraft 10 can be made to fly backward (reverse direction, second movement direction).

Essentially, with the aircraft 10 according to the present embodiment, in order to improve the affinity between the rider 18 and the aircraft 10, the steering apparatus 22 is configured to use manipulations similar to those of the steering handlebar and throttle grip of a motorcycle, except when reversing.

A manipulation amount detection sensor 98, which is formed by a torque sensor or rotational angle sensor, is housed in the steering apparatus 22. The manipulation amount detection sensor 98 detects the rotational angle of the handlebar grip 26R relative to the neutral position, as the manipulation amount (position) of the handlebar grip 26R caused by the rider 18. Furthermore, when the rider 18 steers the steering handlebar 24 around an axis in the up-down direction, the manipulation amount detection sensor 98 detects the steering angle of the steering handlebar 24 relative to the neutral position. Accordingly, the flight controller 80 is capable of controlling the flight of the aircraft 10 based on the manipulation amount and the steering angle detected by the manipulation amount detection sensor 98.

In a state where the rider 18 has rotated the right-side handlebar grip 26R in the P1 direction or the P2 direction, for example, when the rider 18 and the handlebar grip 26R are in a non-contact state due to the rider 18 removing their right hand 25R from the handlebar grip 26R, for example, the handlebar grip 26R is released from the gripping force of the right hand 25R, and returns to the neutral position side due to a spring or the like (not shown in the drawings).

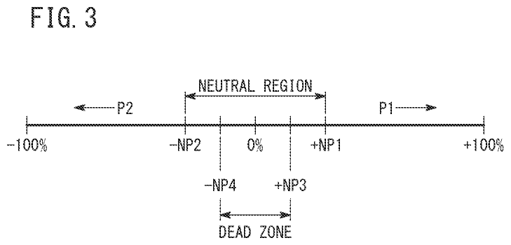

FIG. 3 is a descriptive diagram of a manipulation amount (position) of the handlebar grip 26R caused by the rider 18 (see FIGS. 1 and 2B). Here, the neutral position is 0 [%], the manipulation amount when the handlebar grip 26R has been rotated by a prescribed angle in the P1 direction (e.g., +90 [° ] clockwise in FIG. 2B) relative to the neutral position is +100[%], and the manipulation amount when the handlebar grip 26R has been rotated by a prescribed angle in the P2 direction (e.g., −90 [° ] counter-clockwise in FIG. 2B) relative to the neutral position is −100[%]. In FIGS. 2A to 3, for the sake of convenience in the description, the P1 direction, which is the manipulation direction of the handlebar grip 26R corresponding to the advancing direction of the aircraft 10, is the positive direction (+) and the P2 direction, which is the manipulation direction of the handlebar grip 26R corresponding to the reversing direction of the aircraft 10, is the negative direction (−).

In the present embodiment, a range from +NP1[%] in the P1 direction to −NP2[%] in the P2 direction, with the neutral position as the center, is set as the neutral region (−NP2[%] to +NP1[%]). As described above, after the rider 18 has rotated the handlebar grip 26R in the P1 direction or the P2 direction, when the right hand 25R is removed from the handlebar grip 26R, the handlebar grip 26R is returned to the neutral position by the force of the spring.

Here, in a case where the aircraft 10 is flying in the advancing direction, when the position of the handlebar grip 26R is displaced to the P1 direction side of the neutral region (range of 0[%] to +NP1[%]), the flight controller 80 causes a decelerating force to act on the aircraft 10 in the reversing direction such that the velocity of the aircraft 10 becomes 0. On the other hand, in a case where the aircraft 10 is flying in the reverse direction, when the position of the handlebar grip 26R is displaced to the P2 direction side of the neutral region (range of −NP2[%] to 0[%]), the flight controller 80 causes a decelerating force to act in the advancing direction such that the velocity becomes 0. In the present embodiment, the velocity of the aircraft 10 is set to 0 by causing a decelerating force greater than or equal to the air resistance value to act on the aircraft 10.

In this case, the flight controller 80 may determine the deceleration of the aircraft 10 according to the manipulation amount (position) of the handlebar grip 26R in the neutral region or to the return amount, return velocity, or return acceleration of the handlebar grip 26R to the neutral region. For example, in a case where the position of the handlebar grip 26R has been significantly returned to the neutral region by the right hand 25R of the rider 18, the flight controller 80 judges that the rider 18 is intending to decelerate, and may set the deceleration to be greater the larger this return amount, return velocity, or return acceleration is. Furthermore, the flight controller 80 may set the deceleration to be greater the smaller the manipulation amount of the handlebar grip 26R in the neutral region is or the closer the position of the handlebar grip 26R in the neutral region is to the neutral position. In this way, when the handlebar grip 26R has returned to the neutral position side, the velocity can be quickly made to be 0. The state in which the velocity is 0 refers to a hovering state in which the aircraft 10 is stopped at a prescribed altitude in the air.

There are cases where it is difficult for the manipulation amount detection sensor 98 to precisely detect the manipulation amount (position) of 0 [%], due to a noise component. Therefore, a range of −NP4 [%] to +NP3 [%] in the vicinity of 0[%] in the neutral region may be set as a dead zone of the manipulation amount detection sensor 98. Accordingly, the manipulation amount (position) detected in this dead zone range can be treated as being 0 [%].

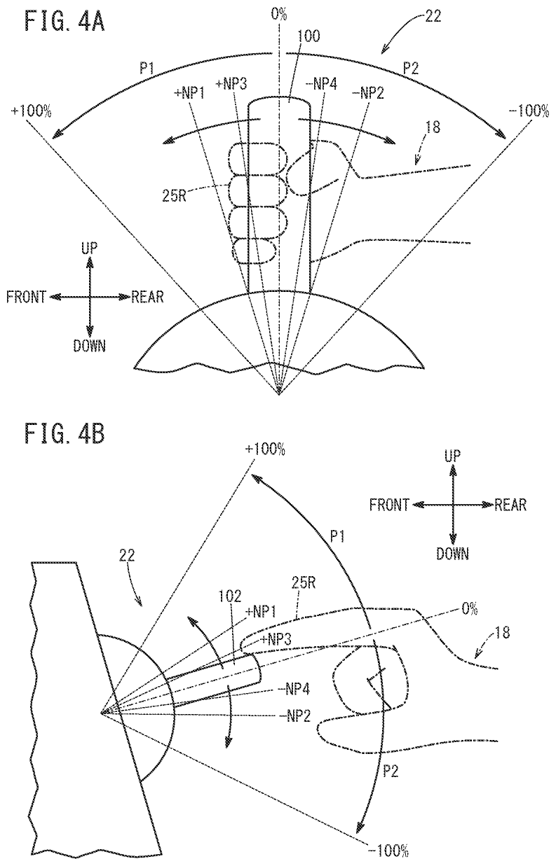

Furthermore, in the aircraft 10 according to the present embodiment, the steering apparatus 22 is not limited to the steering handlebar 24 shown in FIGS. 1 to 2B, and may instead use the configuration shown in FIGS. 4A and 4B.

In FIG. 4A, the steering apparatus 22 is formed by a lever (manipulating section) 100 that simulates a flight stick of an aircraft. In this case, as an example, with an axis in the up-down direction as the neutral position, in a state where the lever 100 is gripped by the rider 18, the rider 18 may lower the lever 100 forward (P1 direction) or backward (P2 direction), centered on the neutral position.

On the other hand, in FIG. 4B, the steering apparatus 22 is formed by a small lever (manipulating section) 102. In this case, as an example, with an axis extending diagonally up and backward as the neutral position, in a state where the rider 18 has gripped the lever 102, the rider 18 may manipulate the lever 102 upward (P1 direction) or downward (P2 direction), centered on the neutral position.

In both of the cases shown in FIGS. 4A and 4B, the aircraft 10 (see FIG. 1) can be made to advance or reverse in accordance with the manipulation amount (position) of the lever 100 or 102 relative to the neutral position. Furthermore, when the lever 100 or 102 has returned to the neutral region due to the force of a spring (not shown in the drawings), a decelerating force can be made to act on the aircraft 10 that is advancing or reversing.

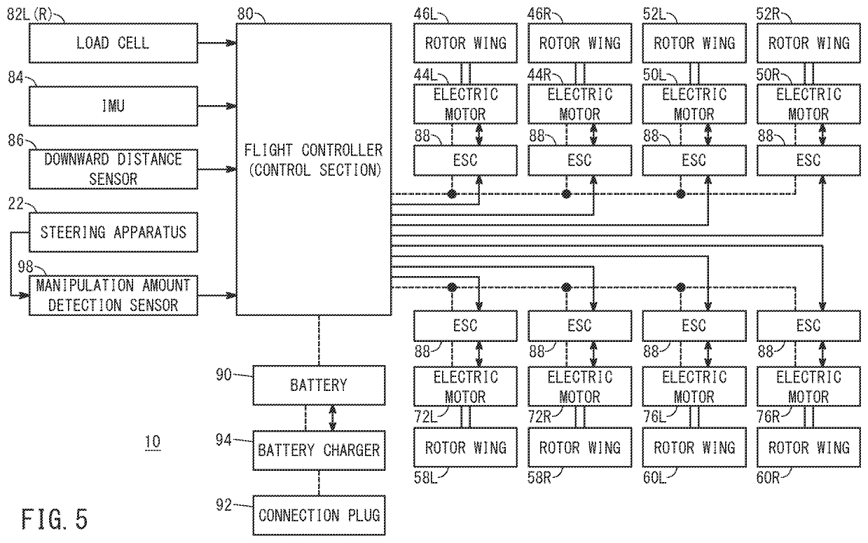

FIG. 5 is a block diagram of the aircraft 10 according to the present embodiment. In FIG. 5, the solid lines indicate signal lines, and the dashed lines indicate power lines.

The flight controller 80 outputs individual command signals to the ESCs 88 of the electric motors 44L, 44R, 50L, 50R, 72L, 72R, 76L, and 76R, based on each of the detection signals from the load cells 82L and 82R, the IMU 84, the downward distance sensor 86, and the manipulation amount detection sensor 98. In this case, the load cells 82L and 82R are arranged on the right and left sides directly below the seat 20 (see FIG. 1), and detect the weight movement amount (center of mass movement amount and rotational amount around an axis in the front-rear direction (roll direction) of the aircraft 10) of the machine including the rider 18. The IMU 84 is formed to include a gyro sensor, and detects the angular velocity and acceleration (posture of the machine) in three axial directions. The downward distance sensor 86 detects the altitude of the aircraft 10 from the ground surface. As described above, the manipulation amount detection sensor 98 detects the manipulation amount of the handlebar grip 26R (see FIGS. 1 to 2B) and the steering angle of the steering handlebar 24.

As described further below, the flight controller 80 is capable of calculating the pitch angle (rotational angle around an axis in the left-right direction) and the velocity of the aircraft 10, based on the detection result of the IMU 84. Therefore, with the present embodiment, instead of or in addition to the IMU 84, a GPS (Global Positioning System, Global Positioning Satellite) sensor, and infrared camera, an RGB camera, a millimeter wave radar, a LiDAR (Light Detection and Ranging, Laser Imaging Detection and Ranging), and the like are loaded in the aircraft 10, and the pitch angle and velocity may be obtained based on the detection results of these detection means. In the following description, a case is described in which the IMU 84 is loaded in the aircraft 10.

By having each ESC 88 independently drive the corresponding electric motor 44L, 44R, 50L, 50R, 72L, 72R, 76L, and 76R based on the command signal, each rotor wing 46L, 46R, 52L, 52R, 58L, 58R, 60L, and 60R is rotationally driven with an individual rotational direction and rotational velocity. As a result, this feature can cause the aircraft 10 to fly in a desired direction and at a desired velocity.

In the present embodiment, in a case where the aircraft 10 is being decelerated, the rotational velocity of one set of motors among the front and rear electric motors 44L, 44R, 50L, 50R, 72L, 72R, 76L, and 76R is set to be less than the rotational velocity of the other set of motors. For example, in a case where the aircraft 10 is flying in the advancing direction, when the aircraft 10 is to decelerate, the rotational velocity of the rear motors should be set to be lower than the rotational velocity of the forward motors.

### [2. Operation of the Present Embodiment]

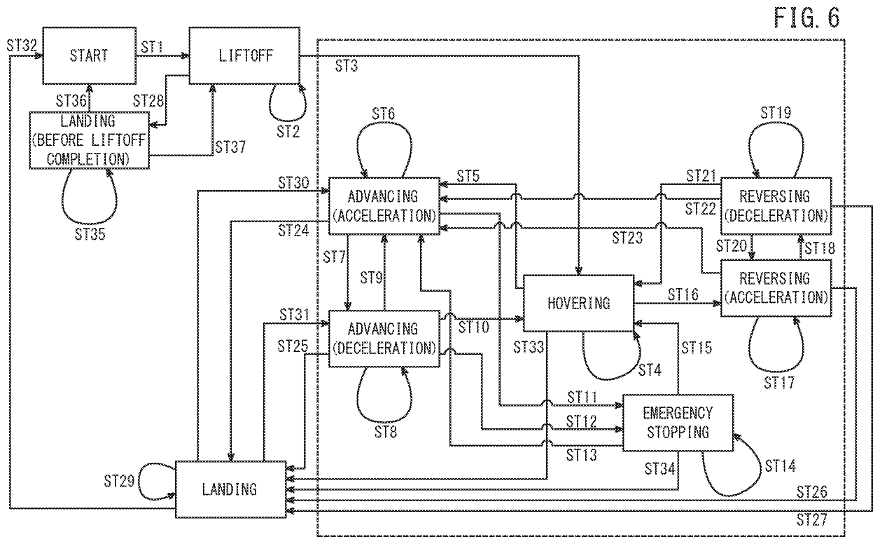

The following describes the operation of the aircraft 10 (control method of the aircraft 10) according to the present embodiment configured as described above, while referencing FIGS. 6 to 11. Also, in the following explanation of the operation, FIGS. 1 to 5 will be referred to as necessary.

### <2.1 Schematic Description of the Series of Operations of the Aircraft 10>

First, the operation of the aircraft 10 according to the present embodiment is described while referencing a state transition diagram of FIG. 6. FIG. 6 shows the transitions in the operational state of a series including the operation start, the liftoff, the flight, the landing, and the operation end of the aircraft 10 (see FIGS. 1 and 5). In the description of FIG. 6, the description concerning the transitioning of the operational state of the aircraft 10 is focused on, and there are cases where descriptions concerning the operations of individual configurational elements forming the aircraft 10 are simplified or omitted.

First, in a state of “start” (also referred to below as the start state), the aircraft 10 is situated on the ground. In this case, when the rider 18 sits on the seat 20 of the aircraft 10 and manipulates a button (not shown in the drawings), the aircraft 10 lifts off from the ground to rise up, and transitions to a state of “liftoff” (also referred to below as a liftoff state), as shown by the transition line ST1. After this, the aircraft 10 automatically rises up to a target altitude, as shown by the transition line ST2.

Next, when the aircraft 10 reaches the target altitude, the aircraft 10 transitions to a state of “hovering” (also referred to below as a hovering state), as shown by the transition line ST3.

In a case where the hovering state is being maintained, the flight controller 80 controls each section in the aircraft 10 in a manner to keep the velocity at 0, as shown by the transition line ST4. In this case, the transition line ST4 is executed on a condition that the manipulation amount (position) of the handlebar grip 26R (see FIGS. 1 to 2B) is in the neutral region, for example.

Essentially, the flight controller 80 recognizes the center of mass movement amount of the machine caused by weight movement of the rider 18, based on the weight movement amount detected by the load cells 82L and 82R, and controls the roll angle of the aircraft 10 (rotational angle around an axis in the front-rear direction) in accordance with the center of mass movement amount. Furthermore, the flight controller 80 controls the pitch angle such that the velocity becomes 0, based on the detection result of the IMU 84. Furthermore, the flight controller 80 controls the yaw rate according to the steering angle of the steering handlebar 24 detected by the manipulation amount detection sensor 98. Yet further, the flight controller 80 controls the altitude of the aircraft 10 according to the altitude of the aircraft 10 detected by the downward distance sensor 86 and the manipulation of buttons (not shown in the drawings) by the rider 18.

Accordingly, by outputting the command signals corresponding to the roll angle, pitch angle, yaw rate, and altitude, which are control quantities, to each ESC 88, the flight controller 80 controls the driving of each electric motor 44L, 44R, 50L, 50R, 72L, 72R, 76L, and 76R to keep the aircraft 10 in the hovering state, as shown by the transition line ST4.

Next, in a case where the rider 18 has rotated the handlebar grip 26R (see FIGS. 1 to 2B) in the P1 direction by a manipulation amount greater than or equal to the neutral region (see FIG. 3) (a case where Manipulation Amount ≥+NP1[%]), the flight controller 80 transitions from the hovering state to a state of “advancing (accelerating)” (also referred to below as the advancing acceleration state), as shown by the transition line ST5. In this way, the aircraft 10 flies while accelerating in the advancing direction, according to the manipulation amount (position) of the handlebar grip 26R by the rider 18.

After this, in a case where the manipulation amount of the handlebar grip 26R in the P1 direction is greater than or equal to +NP1[%] (a case where Manipulation Amount ≥+NP1[%]), the flight controller 80 maintains the advancing acceleration state, as shown by the transition line ST6. In this case as well, the flight controller 80 controls the pitch angle based on the manipulation amount (position) of the handlebar grip 26R detected by the manipulation amount detection sensor 98. Furthermore, the flight controller 80 controls the roll angle and the yaw rate based on the steering angle of the steering handlebar 24 detected by the manipulation amount detection sensor 98 and the weight movement amount detected by the load cells 82L and 82R. Yet further, the flight controller 80 controls the altitude based on the altitude detected by the downward distance sensor 86 and the manipulation of buttons by the rider 18.

Next, in a case where the manipulation amount (position) of the handlebar grip 26R in the P1 direction has returned to the P1 direction side (0[%] to +NP1[%]) of the neutral region, the flight controller 80 transitions the aircraft 10 from the advancing acceleration state to a state of “advancing (deceleration)” (also referred to below as an advancing deceleration state), as shown by the transition line ST7. The advancing deceleration state refers to a state in which the aircraft 10 decelerates while flying in the advancing direction.

After this, in a case where the manipulation amount (position) of the handlebar grip 26R in the P1 direction is on the P1-direction side of the neutral region, the flight controller 80 maintains the advancing deceleration state, as shown by the transition line ST8. In this case, the flight controller 80 controls the pitch angle based on the manipulation amount of the handlebar grip 26R, in the same manner as the transition line ST6. Furthermore, the flight controller 80 controls the roll angle and the yaw rate based on the steering angle of the steering handlebar 24 and the weight movement amount. Yet further, the flight controller 80 controls the altitude based on the altitude detected by the downward distance sensor 86 and the manipulation of buttons by the rider 18.

It should be noted that, in the case of the transition line ST8, the flight controller 80 is set such that the deceleration (decelerating force) in the reversing direction corresponding to the P2 direction becomes greater as the manipulation amount (position) of the handlebar grip 26R becomes smaller (closer to 0[%]). In this way, the aircraft 10 is controlled to automatically approach a velocity of 0 even when the right hand 25R of the rider 18 is removed from the handlebar grip 26R. If the pitch angle is positive (the machine is inclined backward), the aircraft 10 flies in the reversing direction, and if the pitch angle is negative (the machine is inclined forward), the aircraft 10 flies in the advancing direction.

Next, in the advancing deceleration state, if the manipulation amount (position) of the handlebar grip 26R in the P1 direction has become greater than or equal to +NP1 [%] (Manipulation Amount ≥+NP1[%]), the flight controller 80 transitions the aircraft 10 to the advancing acceleration state, as shown by the transition line ST9.

On the other hand, in the advancing deceleration state, if the manipulation amount (position) of the handlebar grip 26R is within a range of −NP2[%] to +NP1[%], i.e., the range of the neutral region, and the absolute value of the velocity is less than or equal to a threshold value near 0, the flight controller 80 transitions the aircraft 10 to the hovering state, as shown by the transition line ST10. In other words, in consideration of the possibility that a velocity of 0 cannot be precisely detected due to the noise component of the IMU 84, if the absolute value of the velocity in the neutral region is less than or equal to the threshold value, this velocity is treated as being close to 0 and the hovering state is transitioned to.

Furthermore, in the advancing acceleration state or the advancing deceleration state, if the manipulation amount (position) of the handlebar grip 26R is in a range from −100[%] to −NP2[%], the flight controller 80 judges that the rider 18 intends to perform emergency deceleration of the aircraft 10, and the aircraft 10 is transitioned to a state of “emergency stopping” (also referred to below as an emergency stopping state), as shown by the transition line ST11 or ST12. In other words, the emergency stopping state corresponds to an emergency braking state of an automobile such as a motorcycle, and refers to a state in which the velocity is suddenly changed to 0.

In the emergency stopping state, if the rider 18 has rotated the handlebar grip 26R toward the P1-direction side such that the manipulation amount (position) of the handlebar grip 26R is within the range from +NP1[%] to +100 [%], i.e., such that the manipulation amount of the handlebar grip 26R is outside of the neutral region on the P1-direction side, the flight controller 80 judges that the rider 18 intends to advance the aircraft 10, and transitions the aircraft 10 to the advancing acceleration state, as shown by the transition line ST13.

Furthermore, in the emergency stopping state, if the absolute value of the velocity is greater than or equal to the threshold value and the manipulation amount (position) of the handlebar grip 26R is in the range from −100[%] to −NP2[%], the flight controller 80 judges that the rider 18 intends to stop the aircraft 10, and maintains the emergency stopping state, as shown by the transition line ST14. In this way, it is possible to decelerate the aircraft 10 such that the velocity quickly becomes 0.

Furthermore, in the emergency stopping state, if the absolute value of the velocity is less than or equal to the threshold value and the manipulation amount (position) of the handlebar grip 26R is in the dead zone that is from −NP4 [%] to +NP3 [%], the flight controller 80 transitions to the hovering state, as shown by the transition line ST15. In other words, in the emergency stopping state, when the handlebar grip 26R is in the neutral region and the absolute velocity has become close to 0, due to the rider 18 removing their right hand 25R from the handlebar grip 26R, the hovering state is transitioned to.

In the hovering state, if the rider 18 has rotated the handlebar grip 26R in the P2-direction side such that the manipulation amount (position) of the handlebar grip 26R is outside the neutral region (is farther to the P2-direction side than −NP2 [%]), the flight controller 80 transitions to a state of “reversing (acceleration)” (also referred to below as a reversing acceleration state), as shown by the transition line ST16. The reversing acceleration state refers to a state in which the aircraft 10 flies while accelerating in the reversing direction. Accordingly, if the aircraft 10 in the hovering state is to be made to advance (transition line ST5) or reverse (transition line ST16), the rider 18 must manipulate the handlebar grip 26R in the P1 direction or P2 direction from the neutral region.

After this, if the manipulation amount (position) of the handlebar grip 26R is farther on the P2-direction side than −NP2[%], the flight controller 80 judges that the rider 18 intends to reverse the aircraft 10, and maintains the reversing acceleration state, as shown by the transition line ST17. In this case as well, the flight controller 80 controls the pitch angle based on the manipulation amount of the handlebar grip 26R, in the same manner as the transition lines ST6 and ST8. Furthermore, the flight controller 80 controls the roll angle and the yaw rate based on the steering amount of the steering handlebar 24 and the weight movement amount. Yet further, the flight controller 80 controls the altitude based on the altitude detected by the downward distance sensor 86 and the manipulation of buttons by the rider 18. When the velocity in the reversing direction has reached a prescribed velocity limit, the flight controller 80 can limit the pitch angle to be an angle that balances the air resistance force with the velocity limit.

In the reversing acceleration state, if the manipulation amount (position) of the handlebar grip 26R is within the neutral region that is from −NP2[%] to +NP1[%], the flight controller 80 transitions the aircraft 10 to a state of “reversing (deceleration)” (also referred to below as a reversing deceleration state), as shown by the transition line ST18. The reversing deceleration state refers to a state in which the aircraft 10 that is flying in the reversing direction decelerates.

After this, if the manipulation amount (position) of the handlebar grip 26R is farther on the P1-direction side than −NP2[%], i.e., if the manipulation amount (position) of the handlebar grip 26R is kept in the neutral region, the flight controller 80 transitions to the reversing deceleration state, as shown by the transition line ST19. In this case as well, the flight controller 80 controls the pitch angle based on the manipulation amount of the handlebar grip 26R, in the same manner as the transition lines ST6, ST8, and ST17. Furthermore, the flight controller 80 controls the roll angle and the yaw rate based on the steering angle of the steering handlebar 24 and the weight movement amount. Yet further, the flight controller 80 controls the altitude based on the altitude detected by the downward distance sensor 86 and the manipulation of buttons by the rider 18. In this case, the acceleration in the reversing direction becomes smaller according to the manipulation amount of the handlebar grip 26R. In other words, the pitch angle is controlled in a negative range.

In the reversing deceleration state, if the manipulation amount (position) of the handlebar grip 26R is farther on the P2-direction side than the neutral region, the flight controller 80 transitions to the reversing acceleration state, as shown by the transition line ST20. Furthermore, in the reversing deceleration state, if the manipulation amount (position) of the handlebar grip 26R is in the neutral region that is from −NP2[%] to +NP1[%] and the absolute value of the velocity is less than the threshold value, the flight controller 80 transitions to the hovering state as shown by the transition line ST21, in the same manner as the transition from the advancing deceleration state to the hovering mode (transition line ST10).

Furthermore, in the reversing deceleration state or the reversing acceleration state, if the manipulation amount (position) of the handlebar grip 26R is farther on the P1-direction side than the neutral region, the flight controller 80 transitions the aircraft 10 to the advancing acceleration state, as shown by the transition line ST22 or ST23.

Yet further, in the advancing acceleration state, the advancing deceleration state, the reversing acceleration state, or the reversing deceleration state, when the rider 18 manipulates a switch (not shown in the drawings) to instruct the aircraft 10 to land, the flight controller 80 transition the aircraft 10 to a state of “landing” (also referred to as a landing state), as shown by the transition lines ST24 to ST28. It should be noted that there are cases where the transition line ST28 is realized when the rider 18 manipulates the switch before the target altitude is reached.

In the landing state, if the rider 18 has manipulated a switch (not shown in the drawings), the flight controller 80 controls the aircraft 10 to land, as shown by the transition line ST29.

Furthermore, in the landing state, if the rider 18 manipulates a switch (not shown in the drawings) and the manipulation amount (position) of the handlebar grip 26R is farther on the P1-direction side than the neutral region, the flight controller 80 transitions the aircraft 10 to the advancing acceleration state, as shown by the transition line ST30. Yet further, in the landing state, if the rider 18 manipulates a switch (not shown in the drawings) and the manipulation amount (position) of the handlebar grip 26R is on the P1-direction side of the neutral region, the flight controller 80 transitions the aircraft 10 to the advancing deceleration state, as shown by the transition line ST31.

Yet further, in the landing state, if the altitude of the aircraft 10 is 0, the flight controller 80 transitions the aircraft 10 to the start state, as shown by the transition line ST32. It should be noted that, due to the noise component of the downward distance sensor 86, there is a possibility that the detected altitude does not become exactly 0. In this case, a prescribed detection range of the downward distance sensor 86 may be set as a dead zone, and an altitude in this dead zone may be treated as being 0.

Furthermore, in the hovering state, the emergency stopping state, or the landing state, when the rider 18 manipulates a switch (not shown in the drawings) to instruct the aircraft 10 to land, the flight controller 80 transitions the aircraft 10 to the landing state, as shown by the transition lines ST33 to ST35. It should be noted that, in the case of the transition line ST35, the landing state is maintained.

In the landing state, if the altitude of the aircraft 10 is 0, the flight controller 80 transitions the aircraft 10 to the start state, as shown by the transition line ST36. Furthermore, in the landing state, when the rider 18 manipulates a switch (not shown in the drawings) to instruct the aircraft 10 to lift off, the flight controller 80 transitions the aircraft 10 to the liftoff state, as shown by the transition line ST37.

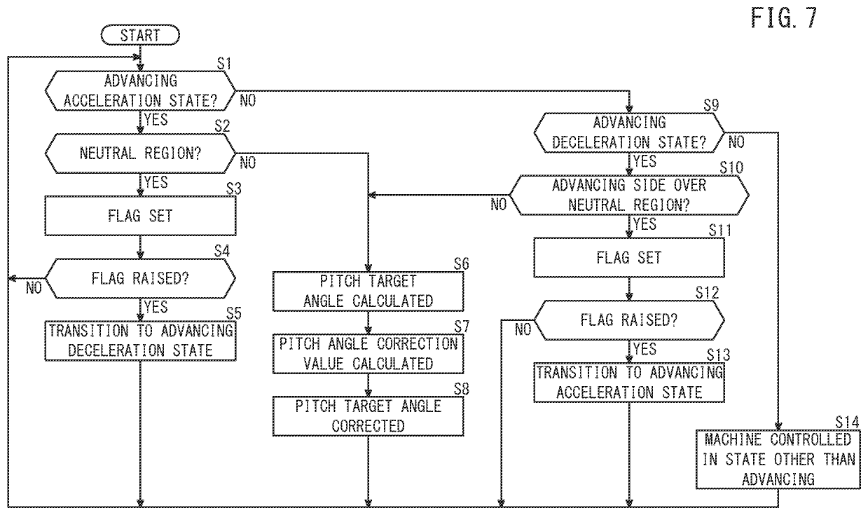

The following describes detailed operation of representative state transitions among the state lines ST1 to ST37 of FIG. 6, while referencing FIGS. 7 to 10. The object performing the operations of FIGS. 7 to 10 is the flight controller 80.

### <2.2 Transition Operation Between Advancing Acceleration State and Advancing Deceleration State>

FIG. 7 is a flow chart showing the details of the state transition of the transition line ST7 or ST9 of FIG. 6.

First, at step S1, the flight controller 80 (see FIGS. 1 and 5) judges whether the current flight state of the aircraft 10 is the advancing acceleration state. If the flight state is the advancing acceleration state (step S1: YES), the process moves to the following step S2.

At step S2, the flight controller 80 judges whether the manipulation amount (position) of the handlebar grip 26R (see FIGS. 1 to 2B) is in the neutral region (see FIG. 3), based on the detection results of the manipulation amount detection sensor 98. If the manipulation amount is in the neutral region (step S2: YES), the process moves to the following step S3.

At step S3, the flight controller 80 sets a flag for permitting the transition from the advancing acceleration state to the advancing deceleration state (state transition permission flag), based on the detection results of the various sensors such as the manipulation amount detection sensor 98. The flight controller 80 sets the flag to “ON (1)” if the state transition is permitted, and sets the flag to “OFF (0)” if the state transition is not permitted.

Cases where the transition from the advancing acceleration state to the advancing deceleration state is not permitted can include, for example, (1) a case where a lower limit value for the absolute value of the velocity is determined according to a regulation or the like and deceleration is prohibited at a velocity that is less than or equal to the lower limit value and (2) a case where there is an obstacle in front of the aircraft 10 and a collision with this obstacle is predicted if deceleration is performed.

At step S4, the flight controller 80 judges whether the flag set at step S3 is raised, i.e., whether the flag is “ON”. If the flag is raised, the process moves to step S5. At step S5, the flight controller 80 controls each section of the aircraft 10 such that the aircraft 10 transitions from the advancing acceleration state to the advancing deceleration state. In other words, the state transition of the transition line ST7 is performed.

After this, the flight controller 80 returns to step S1 and again performs the judgment process of step S1. In other words, the process of FIG. 7 is repeatedly performed while the aircraft 10 is flying.

On the other hand, at step S4, if the flag set in step S3 is not raised (step S4: NO), the flight controller 80 judges that the transition from the advancing acceleration state to the advancing deceleration state is not possible. Due to this, the flight controller 80 returns to step S1 while maintaining the advancing acceleration state.

Furthermore, at step S2, if the manipulation amount (position) of the handlebar grip 26R is not in the neutral region, i.e., if the manipulation amount of the handlebar grip 26R is at or to the P1-direction side of +NP1[%] (Manipulation Amount ≥+NP1[%], step S2: NO), the process moves to step S6. At step S6, the flight controller 80 calculates a target value for the pitch angle (pitch target angle), based on the manipulation amount detected by the manipulation amount detection sensor 98.

At the following step S7, the flight controller 80 calculates a correction amount for the pitch target angle, based on the detection results of the various sensors including the manipulation amount detection sensor 98. At step S8, the flight controller 80 adjusts the pitch target angle to be a pitch angle in accordance with the manipulation amount of the handlebar grip 26R by the rider 18, by correcting the pitch target angle with the correction amount. In this way, by outputting a command signal based on the corrected pitch target angle to each ESC 88 to control each electric motor 44L, 44R, 50L, 50R, 72L, 72R, 76L, and 76R, the flight controller 80 controls the flight of the aircraft 10 in the advancing acceleration state. After this, the flight controller 80 returns to step S1.

On the other hand, at step S1, if the current flight state of the aircraft 10 is not the advancing acceleration state (step S1: NO), the process moves to step S9. At step S9, the flight controller 80 judges whether the current flight state of the aircraft 10 is the advancing deceleration state. If the current flight state is the advancing deceleration state (step S9: YES), the process moves to the following step S10.

At step S10, the flight controller 80 judges whether the manipulation amount (position) of the handlebar grip 26R is farther on the P1-direction side than the neutral region (Manipulation Amount ≥NP1[%]). If the manipulation amount of the handlebar grip 26R is greater than or equal to NP1[%] (step S10: YES), the process moves to step S11. At step S11, the flight controller 80 judges that the rider 18 has manipulated the handlebar grip 26R in the P1 direction with the intention of accelerating, and sets the flag for permitting the transition from the advancing deceleration state to the advancing acceleration state (state transition permission flag). In this case as well, the flight controller 80 sets the flag to “ON (1)” if the state transition is permitted, and sets the flag to “OFF (0)” if the state transition is not permitted.

Cases where the transition from the advancing deceleration state to the advancing acceleration state is not permitted can include, for example, (1) a case where an upper limit value for the absolute value of the velocity is determined according to a regulation or the like and acceleration is prohibited at a velocity that is greater than or equal to the upper limit value and (2) a case where there is an obstacle in front of the aircraft 10 and a collision with this obstacle is predicted if acceleration is performed.

At step S12, the flight controller 80 judges whether the flag set at step S11 is raised, i.e., whether the flag is “ON”. If the flag is raised (step S12: YES), the process moves to step S13. At step S13, the flight controller 80 controls each section of the aircraft 10 such that the aircraft 10 transitions from the advancing deceleration state to the advancing acceleration state. In other words, the state transition of the transition line ST9 is performed. After this, the flight controller 80 returns to step S1.

On the other hand, at step S12, if the flag is not raised (step S12: NO), the flight controller 80 judges that the transition from the advancing deceleration state to the advancing acceleration state is impossible, and returns to step S1 while maintaining the advancing deceleration state.

Furthermore, at step S10, if the manipulation amount (position) of the handlebar grip 26R is not farther on the P1-direction side than the neutral region, e.g., if the manipulation amount of the handlebar grip 26R is in the neutral region (step S10: NO), the processes of steps S6 to S8 are performed in order. In this way, the flight controller 80 can cause the flight control to continue being performed in the advancing deceleration state.

Furthermore, at step S9, if the current flight state of the aircraft 10 is not the advancing deceleration state (step S9: NO), the process moves to step S14. At step S14, the flight controller 80 judges that the current flight state of the aircraft 10 is a state other than advancing, i.e., that the current flight state is the hovering state, reversing state, or the like, and controls the flight of the aircraft 10 in the current state. After this, the flight controller 80 returns to step S1.

### <2.3 Transition Operation Between Advancing Acceleration State and Emergency Stopping State>

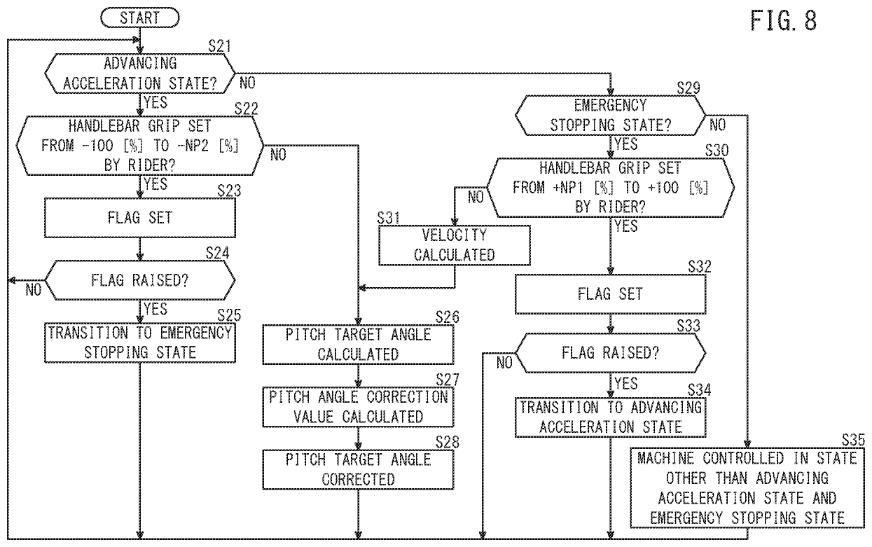

FIG. 8 is a flow chart showing the details of the state transition of the state line ST11 or ST13 of FIG. 6.

First, at step S21, the flight controller 80 (see FIGS. 1 and 5) judges whether the current flight state of the aircraft 10 is the advancing acceleration state. IF the current flight state is the advancing acceleration state (step S21: YES), the process moves to the following step S22.

At step S22, based on the detection result of the manipulation amount detection sensor 98, if the rider 18 has manipulated the handlebar grip 26R (see FIGS. 1 to 2B) in the P2 direction and the manipulation amount (position) of the handlebar grip 26R is in the range from −100[%] to −NP2[%] (step S22: YES), the flight controller 80 moves to the following step S23.

At step S23, the flight controller 80 sets the flag for permitting the transition from the advancing acceleration state to the emergency stopping state (state transmission permission flag), based on the detection results of the various sensors such as the manipulation amount detection sensor 98. In this case as well, the flight controller 80 sets the flag to “ON (1)” if the state transition is permitted, and sets the flag to “OFF (0)” if the state transition is not permitted.

Cases where the transition from the advancing acceleration state to the emergency stopping state is not permitted can include, for example, a case where there is an obstacle in front of the aircraft 10 and a collision with this obstacle is predicted if acceleration is performed, and therefore it is necessary to perform an emergency stop of the aircraft 10.

At step S24, the flight controller 80 judges whether the flag set at step S23 is raised, i.e., whether the flag is “ON”. If the flag is raised, the process moves to step S25. At step S25, the flight controller 80 controls each section of the aircraft 10 such that the aircraft 10 transitions from the advancing acceleration state to the emergency stopping state. In other words, the state transition of the transition line ST11 is performed.

After this, the flight controller 80 returns to step S21 and again performs the judgment process of step S21. The process of FIG. 8 is also repeatedly performed while the aircraft 10 is flying.

On the other hand, at step S24, if the flag set in step S23 is not raised (step S24: NO), the flight controller 80 judges that the transition from the advancing acceleration state to the emergency stopping state is not possible. Due to this, the flight controller 80 returns to step S21 while maintaining the advancing acceleration state.

Furthermore, at step S22, if the manipulation amount (position) of the handlebar grip 26R is not in the range from −100[%] to −NP2[%], i.e., if the manipulation amount of the handlebar grip 26R is at or to the P1-direction side of +NP1[%] (Manipulation Amount ≥+NP1[%], step S22: NO), the process moves to step S26. At step S26, the flight controller 80 judges that the rider 18 intends to accelerate in the advancing direction, and calculates the pitch target angle based on the manipulation amount detected by the manipulation amount detection sensor 98, in the same manner as in step S6 of FIG. 7.

At the following step S27, the flight controller 80 calculates a correction amount for the pitch target angle, based on the detection results of the various sensors, in the same manner as in step S7. At step S28, the flight controller 80 adjusts the pitch target angle to be a pitch angle in accordance with the manipulation amount of the handlebar grip 26R by the rider 18, by correcting the pitch target angle with the correction amount, in the same manner as in step S8. In this case as well, by outputting a command signal based on the corrected pitch target angle to each ESC 88 to control each electric motor 44L, 44R, 50L, 50R, 72L, 72R, 76L, and 76R, the flight controller 80 controls the flight of the aircraft 10 in the advancing acceleration state. After this, the flight controller 80 returns to step S21.

On the other hand, at step S21, if the current flight state of the aircraft 10 is not the advancing acceleration state (step S21: NO), the process moves to step S29. At step S29, the flight controller 80 judges whether the current flight state of the aircraft 10 is the emergency stopping state. If the current flight state is the emergency stopping state (step S29: YES), the process moves to the following step S30.

At step S30, the flight controller 80 judges whether the manipulation amount (position) of the handlebar grip 26R is in the range from +NP1[%] to +100[%] due to the rider 18 manipulating the handlebar grip 26R in the P1 direction, based on the detection result of the manipulation amount detection sensor 98.

If the judgment result of step S30 is negative, e.g., if the manipulation amount (position) of the handlebar grip 26R is in the range from −100[%] to −NP2[%] (step S30: NO), the process moves to the following step S31.

At step S31, the flight controller 80 calculates the velocity of the aircraft 10 based on the detection results of the various sensors including the IMU 84 and the like. After this, the flight controller 80 performs the processes of steps S26 to S28 in order. However, at step S26, the flight controller 80 calculates the pitch target angle while also taking into consideration the velocity calculated at step S31. After this, the flight controller 80 returns to step S21.

On the other hand, at step S30, if the manipulation amount (position) of the handlebar grip 26R is in the range from +NP1[%] to +100[%] (step S30: YES), the process moves to step S32. At step S32, the flight controller 80 judges that the handlebar grip 26R has been manipulated in the P1 direction by the rider 18 with the intent of advancing, and sets the flag for permitting the transition from the emergency stopping state to the advancing acceleration state (state transition permission flag). In this case as well, the flight controller 80 sets the flag to “ON (1)” if the state transition is permitted, and sets the flag to “OFF (0)” if the state transition is not permitted.

Cases where the transition from the emergency stopping state to the advancing acceleration state is not permitted can include, for example, (1) a case where there is an obstacle in front of the aircraft 10 and a collision with this obstacle is predicted if advancing is performed, and (2) a case where the absolute value of the velocity exceeds the upper limit value.

At step S33, the flight controller 80 judges whether the flag set at step S32 is raised, i.e., whether the flag is “ON”. If the flag is raised (step S33: YES), the process moves to step S34. At step S34, the flight controller 80 controls each section of the aircraft 10 such that the aircraft 10 transitions from the emergency stopping state to the advancing acceleration state. In other words, the state transition of the transition line ST13 is performed. After this, the flight controller 80 returns to step S21.

On the other hand, at step S33, if the flag is not raised (step S33: NO), the flight controller 80 judges that the transition from the emergency stopping state to the advancing acceleration state is not possible, and returns to step S21 while maintaining the emergency stopping state.

At step S29, if the current flight state of the aircraft 10 is not the emergency stopping state (step S29: NO), the process moves to step S35. At step S35, the flight controller 80 judges that the current flight state of the aircraft 10 is a state other than the advancing acceleration state and the emergency stopping state, i.e., that the current flight state is the hovering state or the like, and controls the flight of the aircraft 10 in the current state. After this, the flight controller 80 returns to step S21.

<2.4 Transition Operation from Advancing Deceleration State to Emergency Stopping State>

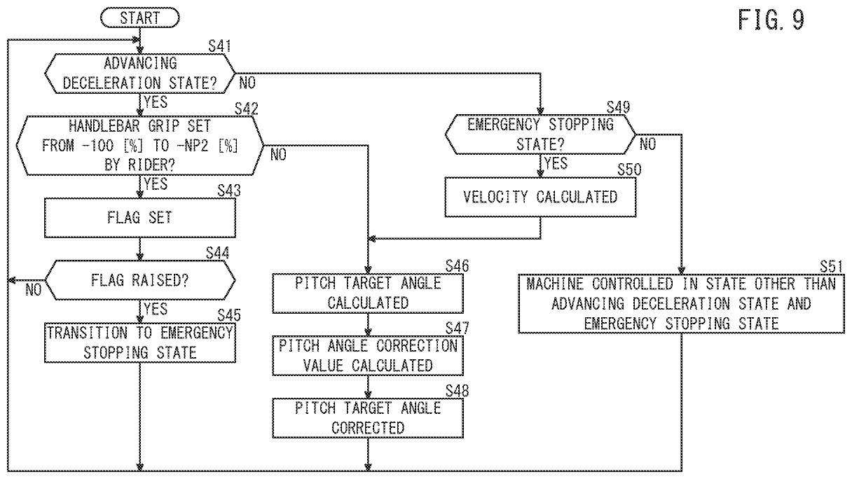

FIG. 9 is a flow chart showing the details of the state transition of the transition line ST12 of FIG. 6.

First, at step S41, the flight controller 80 (see FIGS. 1 and 5) judges whether the current flight state of the aircraft 10 is the advancing deceleration state. If the current flight state is the advancing deceleration state (step S41: YES), the process moves to step S42.

At step S42, based on the detection result of the manipulation amount detection sensor 98, if the rider 18 has manipulated the handlebar grip 26R (see FIGS. 1 to 2B) in the P2 direction and the manipulation amount (position) of the handlebar grip 26R is in the range from −100[%] to −NP2[%] (step S42: YES), the flight controller 80 moves to the following step S43.

At step S43, the flight controller 80 sets the flag for permitting the transition from the advancing deceleration state to the emergency stopping state (state transmission permission flag), based on the detection results of the various sensors such as the manipulation amount detection sensor 98. In this case as well, the flight controller 80 sets the flag to “ON (1)” if the state transition is permitted, and sets the flag to “OFF (0)” if the state transition is not permitted.

Cases where the transition from the advancing deceleration state to the emergency stopping state is not permitted can include, for example, a case where there is an obstacle in front of the aircraft 10 and a collision with this obstacle is predicted if deceleration is performed.

At step S44, the flight controller 80 judges whether the flag set at step S43 is raised, i.e., whether the flag is “ON”. If the flag is raised, the process moves to step S45. At step S45, the flight controller 80 controls each section of the aircraft 10 such that the aircraft 10 transitions from the advancing deceleration state to the emergency stopping state. In other words, the state transition of the transition line ST12 is performed.

After this, the flight controller 80 returns to step S41 and again performs the judgment process of step S41. The process of FIG. 9 is also repeatedly performed while the aircraft 10 is flying.

On the other hand, at step S44, if the flag set in step S43 is not raised (step S44: NO), the flight controller 80 judges that the transition from the advancing deceleration state to the emergency stopping state is not possible. Due to this, the flight controller 80 returns to step S41 while maintaining the advancing deceleration state.

Furthermore, at step S42, if the manipulation amount (position) of the handlebar grip 26R is not in the range from −100[%] to −NP2[%], i.e., if the manipulation amount of the handlebar grip 26R is at or to the P1-direction side of +NP1[%] (Manipulation Amount ≥+NP1[%], step S42: NO), the process moves to step S46. At step S46, the flight controller 80 judges that the rider 18 intends to fly in the advancing direction, and calculates the pitch target angle based on the manipulation amount detected by the manipulation amount detection sensor 98, in the same manner as in step S6 of FIG. 7 and step S26 of FIG. 8.

At the following step S47, the flight controller 80 calculates a correction amount for the pitch target angle, based on the detection results of the various sensors, in the same manner as in steps S7 and S27. At step S48, the flight controller 80 adjusts the pitch target angle to be a pitch angle in accordance with the manipulation amount of the handlebar grip 26R by the rider 18, by correcting the pitch target angle with the correction amount, in the same manner as in steps S8 and S28. In this case as well, by outputting a command signal based on the corrected pitch target angle to each ESC 88 to control each electric motor 44L, 44R, 50L, 50R, 72L, 72R, 76L, and 76R, the flight controller 80 controls the flight of the aircraft 10 in the advancing deceleration state. After this, the flight controller 80 returns to step S41.

On the other hand, at step S41, if the current flight state of the aircraft 10 is not the advancing deceleration state (step S41: NO), the process moves to step S49. At step S49, the flight controller 80 judges whether the current flight state of the aircraft 10 is the emergency stopping state. If the current flight state is the emergency stopping state (step S49: YES), the process moves to the following step S50.

At step S50, the flight controller 80 calculates the velocity of the aircraft 10 based on the detection results of the various sensors including the IMU 84 and the like, in the same manner as in step S31 of FIG. 8. After this, the flight controller 80 performs the processes of steps S46 to S48 in order. In this case as well, at step S46, the flight controller 80 calculates the pitch target angle while also taking into consideration the velocity calculated at step S50. After this, the flight controller 80 returns to step S41.

On the other hand, at step S49, if the current flight state of the aircraft 10 is not the emergency stopping state (step S49: NO), the process moves to step S51. At step S51, the flight controller 80 judges that the current flight state of the aircraft 10 is a state other than the advancing deceleration state and the emergency stopping state, i.e., that the current flight state is the hovering state, a reversing state, or the like, and controls the flight of the aircraft 10 in the current state. After this, the flight controller 80 returns to step S41.

<2.5 Transition Operation from Advancing Deceleration State to Hovering State>

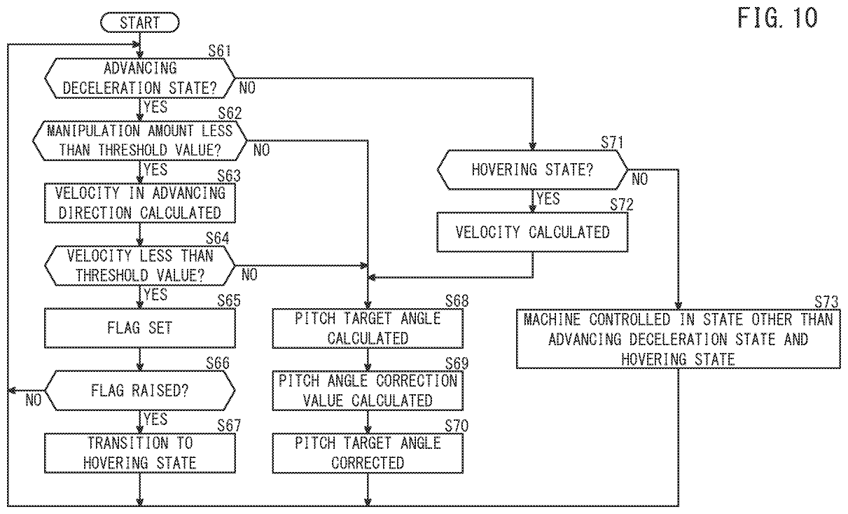

FIG. 10 is a flow chart showing the details of the state transition of the transition line ST10 of FIG. 6.

First, at step S61, the flight controller 80 (see FIGS. 1 and 5) judges whether the current flight state of the aircraft 10 is the advancing deceleration state. If the current flight state is the advancing deceleration state (step S61: YES), the process moves to step S62.

At step S62, based on the detection result of the manipulation amount detection sensor 98, the flight controller 80 judges whether the rider 18 has manipulated the handlebar grip 26R (see FIGS. 1 to 2B) in the P2 direction and the manipulation amount (position) of the handlebar grip 26R is less than the threshold value, specifically whether the manipulation amount has returned to be within the neutral region (see FIG. 3). If the manipulation amount is less than the threshold value (step S62: YES), the flight controller 80 moves to the following step S63.

At step S63, the flight controller 80 calculates the velocity of the aircraft 10 based on the detection results of the various sensors such as the IMU 84.

At step S64, the flight controller 80 judges whether the absolute value of the calculated velocity is less than the threshold value, i.e., whether the absolute value of the velocity is in the dead zone. If the absolute value of the velocity is less than the threshold value (step S64: YES), the process moves to the following step S65.

At step S65, the flight controller 80 sets the flag for permitting the transition from the advancing deceleration state to the hovering state (state transmission permission flag), based on the detection results of the various sensors such as the manipulation amount detection sensor 98. In this case as well, the flight controller 80 sets the flag to “ON (1)” if the state transition is permitted, and sets the flag to “OFF (0)” if the state transition is not permitted.

Cases where the transition from the advancing deceleration state to the hovering state is not permitted can include, for example, a case where there is an obstacle in front of the aircraft 10 and a collision with this obstacle is predicted if the hovering state is entered.

At step S66, the flight controller 80 judges whether the flag set at step S65 is raised, i.e., whether the flag is “ON”. If the flag is raised, the process moves to step S67. At step S67, the flight controller 80 controls each section of the aircraft 10 such that the aircraft 10 transitions from the advancing deceleration state to the hovering state. In other words, the state transition of the transition line ST10 is performed.

After this, the flight controller 80 returns to step S61 and again performs the judgment process of step S61. The process of FIG. 10 is also repeatedly performed while the aircraft 10 is flying.

On the other hand, at step S66, if the flag set in step S65 is not raised (step S66: NO), the flight controller 80 judges that the transition from the advancing deceleration state to the hovering state is not possible. Due to this, the flight controller 80 returns to step S61 while maintaining the advancing deceleration state.

Furthermore, at step S62 or S64, if the determination result is negative (step S62 or S64: NO), the process moves to step S68. At step S68, the flight controller 80 judges that the rider 18 intends to advance the aircraft 10, and calculates the pitch target angle based on the manipulation amount detected by the manipulation amount detection sensor 98, in the same manner as in step S6 of FIG. 7, step S26 of FIG. 8, and step S46 of FIG. 9.

At the following step S69, the flight controller 80 calculates a correction amount for the pitch target angle, based on the detection results of the various sensors, in the same manner as in steps S7, S27, and S47. At step S70, the flight controller 80 adjusts the pitch target angle to be a pitch angle in accordance with the manipulation amount of the handlebar grip 26R by the rider 18, by correcting the pitch target angle with the correction amount, in the same manner as in steps S8, S28, and S48. In this case as well, by outputting a command signal based on the corrected pitch target angle to each ESC 88 to control each electric motor 44L and 44R, the flight controller 80 controls the flight of the aircraft 10 in the advancing deceleration state. After this, the flight controller 80 returns to step S61.

On the other hand, at step S61, if the current flight state of the aircraft 10 is not the advancing deceleration state (step S61: NO), the process moves to step S71. At step S71, the flight controller 80 judges whether the current flight state of the aircraft 10 is the hovering state. If the current flight state is the hovering state (step S71: YES), the process moves to the following step S72.

At step S72, the flight controller 80 calculates the velocity of the aircraft 10 based on the detection results of the various sensors including the IMU 84 and the like. After this, the flight controller 80 performs the processes of steps S68 to S70 in order. However, at step S68, the flight controller 80 calculates the pitch target angle while also taking into consideration the velocity calculated at step S72. After this, the flight controller 80 returns to step S61.

At step S71, if the current flight state of the aircraft 10 is not the hovering state (step S71: NO), the process moves to step S73. At step S73, the flight controller 80 judges that the current flight state of the aircraft 10 is a state other than the advancing deceleration state and the hovering state, i.e., that the current flight state is the emergency stopping state, a reversing state, or the like, and controls the flight of the aircraft 10 in the current state. After this, the flight controller 80 returns to step S61.

### <2.6 Modification of the State Transition Diagram of FIG. 6>

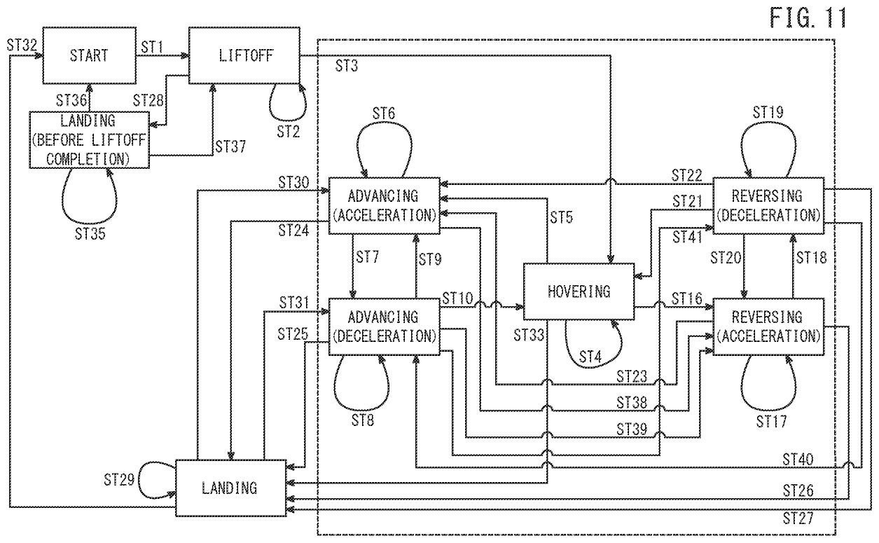

FIG. 11 is a modification of the state transition diagram of FIG. 6. FIG. 11 differs from FIG. 6 in that there is no emergency stopping state. Therefore, in FIG. 11, the transition lines ST11 to ST15 and ST34 that relate to the emergency stopping state are omitted, and transition lines ST38 to ST41 are added instead.

The transition line ST38 is a line of a transition from the advancing acceleration state to the reversing acceleration state, and the transition line ST39 is a line of a transition from the advancing deceleration state to the reversing acceleration state. The transition lines ST38 and ST39 each include, in the advancing acceleration state or advancing deceleration state, making a state transition to the reversing acceleration state when the manipulation amount (position) of the handlebar grip 26R (see FIGS. 1 to 2B) is farther on the P2-direction side than the neutral region (see FIG. 3).

The transition line ST40 is the line of a transition from the reversing deceleration state to the advancing deceleration state. In this case, in the reversing deceleration state, a state transition is made to the advancing deceleration state when the manipulation amount (position) of the handlebar grip 26R has returned to the neutral region and the velocity of the aircraft 10 (see FIGS. 1 and 5) in the advancing direction is greater than 0.

For example, if the aircraft 10 is flying forward in the advancing acceleration state, when the rider 18 returns the manipulation amount (position) of the handlebar grip 26R to a range on the P2-direction side of the neutral region, the aircraft 10 transitions to the reversing acceleration state and flies backward. After this, when the rider 18 returns the handlebar grip 26R to the P1-direction side and the manipulation amount of the handlebar grip 26R falls within the neutral region, there is a possibility that the aircraft 10 will transition to the reversing deceleration state and fly. In such a case, since the rider 18 has returned the manipulation amount of the handlebar grip 26R to the neutral region, it can be thought that the rider 18 intends to decelerate the aircraft 10. Therefore, even if the aircraft 10 enters the reversing deceleration state while tilting forward, the backward flying continues. In such a case, the aircraft 10 is quickly transitioned to the advancing deceleration state.

The transition line ST41 is a line of a transition from the advancing deceleration state to the reversing deceleration state. In this case, in the advancing deceleration state, the state transition to the reversing deceleration state is performed if the manipulation amount (position) of the handlebar grip 26R has returned to the neutral region and the velocity of the aircraft 10 in the reversing direction is greater than 0.

### [3. Effect of the Present Embodiment]

As described above, with the aircraft 10 and the control method thereof according to the present embodiment, the aircraft 10 includes the handlebar grip 26R or the lever 100 or 102 (manipulating section) that is manipulated by the rider 18 and the flight controller (control section) 80 that controls the flight in the air based on the manipulation of the handlebar grip 26R or the lever 100 or 102 (manipulating section) by the rider 18.

In this case, the handlebar grip 26R or the lever 100 or 102 is manipulated in the P1 direction (first manipulation direction) relative to the neutral position or in the P2 direction (second manipulation direction) that is different than the P1 direction relative to the neutral position, and a prescribed range in the P1 direction and P2 direction centered on the neutral position is set as the neutral region for the manipulating section.

Furthermore, the flight controller 80 moves the aircraft 10 in the advancing direction (first movement direction) according to the manipulation amount of the handlebar grip 26R or the lever 100 or 102 in the P1 direction from the neutral position, and moves the aircraft 10 in the reversing direction (second movement direction) that is different than the advancing direction according to the manipulation amount of the handlebar grip 26R or the lever 100 or 102 in the P2 direction from the neutral position. Furthermore, the flight controller 80 decelerates the aircraft 10 if the position of the handlebar grip 26R or the lever 100 or 102 that has been manipulated in the P1 direction or P2 direction has moved into the neutral region.

In this way, if the position of the handlebar grip 26R or the lever 100 or 102 is moved into the neutral region while the aircraft 10 is in flight, the aircraft 10 decelerates, and therefore it is possible for the velocity of the aircraft 10 to quickly become 0, i.e., for the aircraft 10 to enter the hovering state. Therefore, it is possible to realize a fail-safe during an emergency, with a simple configuration.

In this case, the flight controller 80 decelerates the aircraft 10 when the rider 18 has manipulated the handlebar grip 26R or the lever 100 or 102 into the neutral region from the P1 direction or P2 direction. In this way, the aircraft 10 is decelerated when the rider 18 shows intent to decelerate by manipulating the handlebar grip 26R or the lever 100 or 102, and therefore it is possible to make the aircraft 10 fly appropriately according to the intent of the rider 18.

Furthermore, when the position of the handlebar grip 26R or the lever 100 or 102 has been moved into the neutral region due to the handlebar grip 26R or the lever 100 or 102 entering a non-contact state with the rider 18, the flight controller 80 may decelerate the aircraft 10. In this way, when the rider 18 has unintentionally removed their right hand 25R, the aircraft 10 can be decelerated to enter the hovering state. As a result, it is possible to realize a simple and easy fail-safe.

Yet further, the flight controller 80 may determine the deceleration of the aircraft 10 according to the return amount, the return velocity, or the return acceleration at which the handlebar grip 26R or the lever 100 or 102 returns to the neutral region from the P1 direction or the P2 direction. In this way, it is possible to accurately decelerate the aircraft 10 according to the intent of the rider 18, such as by making the deceleration greater as the return amount, return velocity, or return acceleration becomes greater.

Yet further, the flight controller 80 may determine the deceleration of the aircraft 10 according to the manipulation amount or position of the handlebar grip 26R or the lever 100 or 102 in the neutral region. In this way, when the rider 18 has returned the manipulation amount or position of the handlebar grip 26R or the lever 100 or 102 to the neutral region, the aircraft 10 can be reliably decelerated.

In this case, the flight controller 80 may cause the deceleration of the aircraft 10 to be greater as the manipulation amount of the handlebar grip 26R or the lever 100 or 102 in the neutral region becomes smaller or as the position of the handlebar grip 26R or the lever 100 or 102 in the neutral region becomes closer to the neutral position. In this way, the discomfort felt by the rider 18 when the aircraft 10 decelerates is lessened, and the rider 18 can steer the aircraft 10 with the same feeling as a vehicle such as a motorcycle.

Furthermore, the P1 direction and the P2 direction are directions opposite to each other centered on the neutral position, and the advancing direction and reversing direction, which are progression directions of the aircraft 10, are opposite to each other. Therefore, the rider 18 can cause the aircraft 10 to fly by manipulating the handlebar grip 26R or the lever 100 or 102 without feeling discomfort.

In this case, the handlebar grip 26R is gripped by the rider 18 and rotated in the P1 direction or P2 direction centered on the neutral position, but the levers 100 and 102 are manipulated in the P1 direction or the P2 direction centered on the neutral position. In this way, the rider 18 can cause the aircraft 10 to fly by easily manipulating the handlebar grip 26R or the lever 100 or 102.

The present invention is not limited to the above-described embodiment, and it goes without saying that various configurations could be adopted therein based on the content described in the Specification.

What is claim is:

1. An aircraft comprising a manipulating section that is manipulated by a rider and a control section that controls flight in air based on manipulation of the manipulating section by the rider, wherein:
the manipulating section is manipulated by the rider in a first manipulation direction relative to a neutral position or in a second manipulation direction, which is different than the first manipulation direction, relative to the neutral position;
a prescribed range in the first manipulation direction and the second manipulation direction, centered on the neutral position, is set as a neutral region for the manipulating section; and
the control section:
moves the aircraft in a first movement direction according to a manipulation amount of the manipulating section in the first manipulation direction from the neutral position, or moves the aircraft in a second movement direction, which is different than the first movement direction, according to a manipulation amount of the manipulating section in the second manipulation direction from the neutral position; and
decelerates the aircraft if a position of the manipulating section that has been manipulated in the first manipulation direction or the second manipulation direction has moved into the neutral region.

2. The aircraft according to claim 1, wherein the control section decelerates the aircraft when the rider has manipulated the manipulating section into the neutral region from the first manipulation direction or the second manipulation direction.

3. The aircraft according to claim 1, wherein the control section decelerates the aircraft when the position of the manipulating section has been moved into the neutral region due to the manipulating section entering a non-contact state with the rider.

4. The aircraft according to claim 2, wherein the control section determines deceleration of the aircraft according to a return amount, a return velocity, or a return acceleration at which the manipulating section returns to the neutral region from the first manipulation direction or the second manipulation direction.

5. The aircraft according to claim 1, wherein the control section determines deceleration of the aircraft according to a manipulation amount or position of the manipulating section in the neutral region.

6. The aircraft according to claim 5, wherein the control section causes the deceleration of the aircraft to be greater as the manipulation amount of the manipulating section in the neutral region becomes smaller or as the position of the manipulating section in the neutral region becomes closer to the neutral position.

7. The aircraft according to claim 1, wherein the first manipulation direction and the second manipulation direction are directions opposite to each other centered on the neutral position, and
the first movement direction and the second movement direction are directions opposite to each other.

8. The aircraft according to claim 7, wherein the first movement direction is an advancing direction of the aircraft, and
the second movement direction is a reversing direction of the aircraft.

9. The aircraft according to claim 7, wherein the manipulating section is a handlebar grip that, in a state of being gripped by the rider, is rotated in the first manipulation direction or the second manipulation direction centered on the neutral position, or is a lever that is manipulated by the rider in the first manipulation direction or the second manipulation direction centered on the neutral position.

10. A control method of an aircraft including a manipulating section that is manipulated by a rider and a control section that controls flight in air based on manipulation of the manipulating section by the rider, the method comprising:
manipulating the manipulating section by the rider in a first manipulation direction relative to a neutral position or in a second manipulation direction, which is different than the first manipulation direction, relative to the neutral position, and setting a prescribed range in the first manipulation direction and the second manipulation direction, centered on the neutral position, as a neutral region for the manipulating section;
moving the aircraft by the control section in a first movement direction according to a manipulation amount of the manipulating section in the first manipulation direction from the neutral position, or moving the aircraft by the control section in a second movement direction, which is different than the first movement direction, according to a manipulation amount of the manipulating section in the second manipulation direction from the neutral position; and
decelerating the aircraft by the control section if a position of the manipulating section that has been manipulated in the first manipulation direction or the second manipulation direction has moved into the neutral region.
